(19) United States
(12) Patent Application Publication
(10) Pub. No.: US 2006/0245587 A1
(43) Pub. Date: Nov. 2, 2006

(54) System and method for private information matching

(76) Inventors: Binyamin Pinkas, Tel Aviv (IL); Michael Freedman, Kingston, PA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/117,765

(22) Filed: Apr. 28, 2005

(51) Int. Cl. H04L 9/28

(52) U.S. Cl. 380/28

(57) ABSTRACT

A system and method for confidentially matching information among parties are disclosed. Briefly described, one embodiment is a method comprising receiving from a first party a list of items, determining an encrypted polynomial P(y) from the first party's list of items, communicating the encrypted polynomial P(y) to a second party, receiving from the second party a list of second items, evaluating the encrypted polynomial P(y) at points defined by the second party's list of items, such that an output is determined, determining an encrypted output, the encrypted output corresponding to the output, communicating the encrypted output to the first party, decrypting the received encrypted output and determining an intersection between the first list of items and the second list of items based upon decryption of the received encrypted output.

### TECHNICAL FIELD

Embodiments are generally related to information matching and, more particularly, are related to a system and method for confidentially matching information among a plurality of parties.

### BACKGROUND

Two parties may wish to learn about certain commonalties between them. For instance, a first party may have a list of items that they would like to compare with a second party's list of items. However, in some situations, the parties may desire to limit the exchange of information and/or keep aspects of the information confidential.

It may be desirable, as a result of the comparison, to indicate limited information pertaining to the commonalties. At a minimum, the comparison may indicate a numerical relationship defining the magnitude of the commonalties (number of instances of matches between the lists). For example, if the compared list contains one hundred (100) elements, parties would understand that there may be a relatively high degree of correlation between the lists if ninety of the hundred items corresponded during the comparison. On the other hand, a relatively low degree of correlation would be appreciated if only five of the items corresponded.

In other situations, it may be desirable to share information pertaining to common items on the list, but only after such common items have been identified. For example, a law enforcement agency may have a list of wanted suspects and a hotel may have a list of registered guests. Both the law enforcement agency and the hotel would, presumably, desire to initially keep information regarding the suspects and guests confidential, particularly for those suspects and guests that are not members of both the list of suspects and the guest registry. At a later time, information pertaining to the common items might be shared. For example, the hotel might provide the room number of a wanted suspect when identified as a hotel guest.

Also, in some situations, one of the parties may not receive information regarding the comparison results. For example, the law enforcement agency may be performing comparisons between their suspect list and many hotels in a region of interest. The hotels might have no significant interest in knowing if any of their guests were wanted suspects. Accordingly, the hotels would not be notified of the comparison results.

In other situations, it may be desirable to compare more that two lists. For example, the hotel guest registry may be compared with lists for two or more different law enforcement agencies. If a wanted suspect is identified as a hotel guest, then the multiple law enforcement agencies wanting that suspect may desire to work in cooperation to apprehend the wanted suspect.

Other exemplary scenarios of confidentially comparing information can be envisioned. For example, dating services may provide a matching service to a group of females and a group of males. During the matching process, comparing lists of information may be a very useful tool for identifying potential matches. For example, one of the members may be conducting self-screenings of members of the other group (the search group) to identify members that may be of interest. If, during the comparison, a relatively high number of common items are identified between the screening party and a member of the search group, the screening party may wish to initiate contact with that member of the search group. During such screening processes, members of the search group may desire to limit access to specific information on the list of compared items. Accordingly, the screening party may only be provided information corresponding to the number of matching instances, or generalized information pertaining to a matched list element (such as “both of you enjoy movies”).

Another exemplary situation where comparing two lists would be desirable is a situation identifying employees of a company and medical records of a patients to a health care provider. In such situations, strict confidentiality of patient and employee names is required. However, determining information regarding matches between the lists could be very desirable. For example, instances of specific diseases of interest related to the work place could be determined.

One prior art technique for confidentially comparing two lists is to employ a trusted third party. The trusted third party would receive the lists from the first and second parties, perform the comparison, and then provide the parties information corresponding to common items on the lists. Accordingly, the trusted third party can provided limited information pertaining to matching items, while maintaining the confidentiality of other, non-matching items.

However, such trusted third party solutions has several drawbacks. First, a trusted third party acceptable to both parties must be identified. Second, an agreement must be in place which clearly defines the criteria of comparison, clearly defines the nature of the information that is to be provided regarding the comparison results, and clearly defines which parties are to receive what type of information. Third, the process of identifying the trusted third party, providing the lists and associated information to the trusted third party, the preparation of the comparison results by the trusted third party, and the return of the comparison results to the parties per the agreement may take a considerable amount of time. These difficulties, and other disadvantages not discussed herein, may make the use of a trusted third party undesirable.

As an alternative, one party could directly provide to the other party their list. Assuming that the receiving party is trustworthy and will act with a high degree of integrity, many of the disadvantages of the trusted third party can be overcome. However, there is no guarantee that the receiving party is, in fact, trustworthy. Furthermore, the receiving party will necessarily have access to all information on the received list.

Accordingly, it is desirable for providing a system and method for confidentially comparing items on different lists.

### SUMMARY

One embodiment for confidentially matching information among parties may comprise receiving from a first party a list of items, determining an encrypted polynomial P(y) from the first party's list of items, communicating the encrypted polynomial P(y) to a second party, receiving from the second party a list of second items, evaluating the encrypted polynomial P(y) at points defined by the second party's list of items such that an output is determined, determining an encrypted output, the encrypted output corresponding to the output, communicating the encrypted output to the first party, decrypting the received encrypted output and determining an intersection between the first list of items and the second list of items based upon decryption of the received encrypted output

Another embodiment may comprise a list of items generated by a first party; a first processing system configured to determine an encrypted polynomial P(y) from the first party's list of items and configured to communicate the encrypted polynomial P(y) to a second processing system; a list of second items generated by a second party; and the second processing system configured to evaluate the encrypted polynomial P(y) at the second party's list of items such that an output is determined, configured to determine an encrypted output from the output, configured to communicating the encrypted output to the first processing system, such that the first processing system decrypts the received encrypted output and determines an intersection between the first list of items and the second list of items based upon decryption of the received encrypted output.

### BRIEF DESCRIPTION OF THE DRAWINGS

The components in the drawings are not necessarily to scale relative to each other. Like reference numerals designate corresponding parts throughout the several views.

FIG. 1 is a block diagram of an embodiment of a private information matching system.

FIG. 2 is a block diagram of a multi-party embodiment of a private information matching system.

FIG. 3 is a flowchart illustrating an embodiment of a process for confidentially matching information among parties.

### DETAILED DESCRIPTION

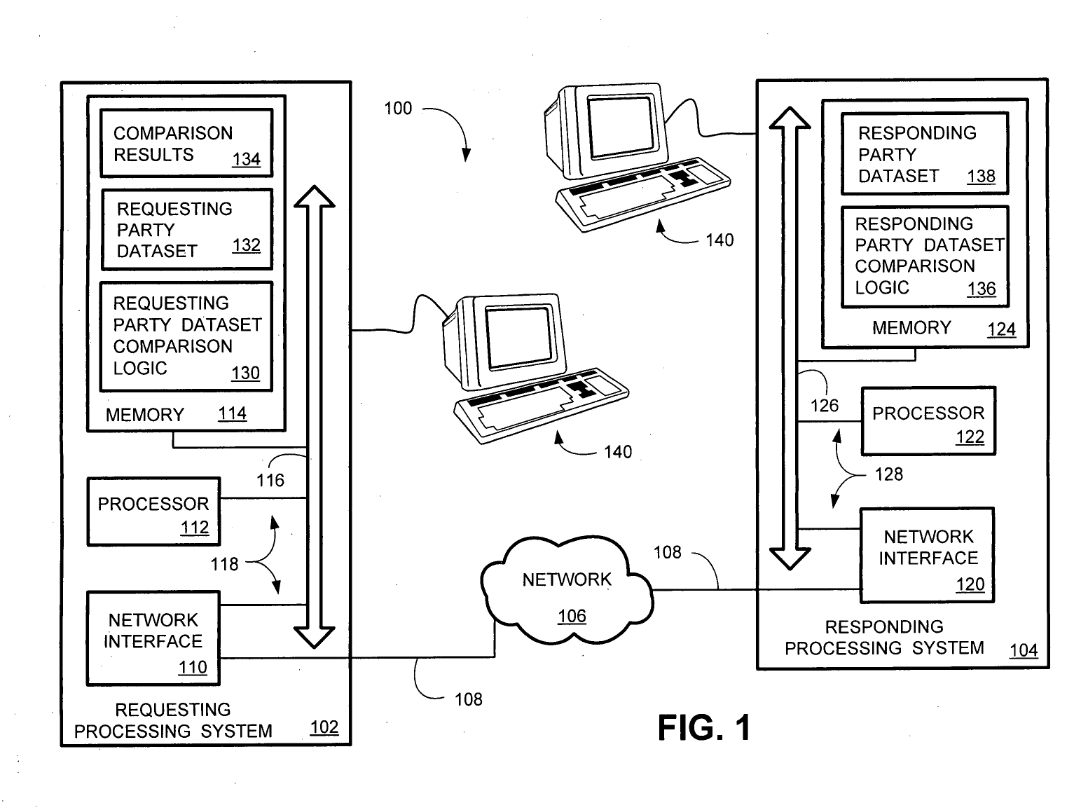

The basic consideration is the problem of computing the intersection of private datasets of two or more parties, where the datasets contain lists of elements taken from a large domain. That is, the protocols of the various embodiments of the private information matching system 100 (FIG. 1) enable multiple parties, each holding a set of inputs (drawn from a large domain) to jointly calculate the intersection of their inputs without disclosing any additional information.

FIG. 1 is a block diagram of an embodiment of a private information matching system 100. The private information matching system 100 provides a system and method for confidentially comparing items on two or more lists.

The exemplary embodiment illustrated in FIG. 1 comprises a requesting processing system 102 and a responding system 104. The systems 102 and 104 communicate with each other via a suitable network 106, via network connections 108. The requesting processing system 102 comprises at least a network interface 110, a processor 112 and a memory 114. Network interface 110, a processor 112 and a memory 114 are communicatively coupled together over communication bus 116, via connections 118. The responding processing system 104 comprises at least a network interface 120, a processor 122 and a memory 124. Network interface 120, processor 122 and memory 124 are communicatively coupled together over communication bus 126, via connections 128.

With respect to the requesting processing system 102, the requesting party dataset comparison logic 130, the requesting party dataset 132 and the comparison results 134 reside in memory 114. For convenience, logic 130, requesting party dataset 132 and comparison results 134 are illustrated as residing in a single memory 114. In other embodiments, they may reside separately in other suitable memory media accessible by the requesting party.

Embodiments of the private information matching system 100 provide a protocol for secure computation of the intersection of sets held by two or more parties. Cardinality set intersection results may be provided by the various embodiments where the output is limited to indicating the size of the intersection, but not its contents. Other embodiments may provide a threshold set intersection, where the output is 1 if the size of the intersection is greater than some threshold, and 0 otherwise. Yet other embodiments may provide an output corresponding to some other function of the contents of the intersection, or of its size.

Some embodiments may be configured to provide payload protocols, where in addition to learning the items in the intersection, the output contains information associated with these items. For example, in the two-party case, assume that the requesting party is a law enforcement agency and the responding party is a hotel. If a person appears in an intersection list corresponding to the intersection of a wanted suspect list kept by the law enforcement agency and a the guest list of the hotel, then the law enforcement agency learns the guest's identity. In addition, other information that the hotel keeps for this guest may be provided to the law enforcement agency (such as room numbers or credit card numbers, for instance). The law enforcement agency learns no information about other guests of the hotel, and the hotel does not learn which guests appear in the intersection between its list and the list kept by the law enforcement agency. Here, only the requesting party, the law enforcement agency, receives information corresponding to the intersection of the lists. On the other hand, embodiments may be configured to also provide information to the responding party, here the hotel.

Various embodiments of the information matching system 100 provide a secure computation (privacy preserving computation). In the two-party case, two parties with private inputs may wish to compute some function of their inputs while revealing no other information about the nature of the inputs or information pertaining to the inputs. Namely, the process, or distributed protocol, of computing the function should not reveal any intermediate results to one or more of the parties, but rather reveal only the final output of the function.

This privacy preserving computation is conceptually modeled in the following way: consider an “ideal” scenario, where in addition to the two parties, we have a trusted third party (TTP). The two parties can send their inputs to the TTP, which can then compute the desired function and send the result to the parties. In this case, it is clear that the parties learn nothing but the final output of the function. Here, it is required that the same property holds for the secure computation protocol, which involves the two parties alone, with no additional TTP.

The multi-party case is similar to the two-party case. It involves multiple parties which have private inputs and wish to compute some function of their inputs while revealing no other information about them. Namely, the parties learn no more information than is available in an “ideal” scenario where there is a trusted party which receives the requesting and responding parties' inputs, computes the desired function, and sends limited comparison results to the requesting and/or responding parties. The returned comparison results need not necessarily be the same if results are provided to both the requesting and responding parties.

Various embodiments may provide a relatively simpler form of private matching, the private equity test (PET). This is the case where there are two parties and each of the two datasets contains a single element from a domain of size N. Namely, this case involves two parties where each party has a single input element. The parties want to find out whether their two inputs are the same. Namely, they compute a function whose value is 1 if the two inputs are equal, and 0 otherwise.

There are generic secure computation protocols for computing any function, in either the two-party scenario or the multi-party scenario. These constructions typically work by first encoding the function as a Boolean or algebraic circuit (using Boolean or algebraic gates), and then running a generic protocol which implements secure computation for this circuit. Although these constructions can be applied to computing any function, the overhead of the resulting solution is high if the resulting circuit representation of the function is not very small (as is the case with the set intersection problem described here).

On the other hand, there are functions, such as the private equality test, which can be efficiently represented by a circuit. For example, in this case a circuit for comparing two values out of a domain of size N is of size log(N), and the private equality test function can therefore can be securely evaluated with this overhead. Or, specialized protocols for this function may be used with essentially the same overhead.

Following is a list of prior art techniques for private matching.

A straightforward circuit-based solution for computing private matching of two datasets of k elements requires O(kˆ2 log N) communication and O(k log N) oblivious transfers. This overhead is not optimal since it is quadratic in k.

Another trivial construction for the two-party case compares all combinations of one item from each of the two datasets using kˆ2 instantiations of a PET protocol (which itself has O(log N) overhead]. The computation of this comparison can be reduced to O(k log N), while retaining the O(kˆ2 log N) communication overhead. A specific solution for the multi-party scenario was not explicitly described before, but one could imagine that it would be even less efficient than the solutions for the two-party case.

There are additional constructions that solve the two-party private matching problem at the cost of only O(k) exponentiations. However, these constructions have several disadvantages compared to ours:
a. they only apply to the two-party case,
b. their security was not analyzed,
c. they are only secure if the parties follow the protocols, and there are no explicit guarantees against arbitrary malicious behavior of the parties, and
d. they do not discuss other variants of the problem, such as private threshold intersection (discussed below) or further generalizations

Embodiments of the private information matching system 100 (FIG. 1) provide secure and confidential two-party protocols for a private matching (PM) scheme between a requesting party, hereinafter referred to as the chooser or client (C), and a responding party, hereinafter referred to as the sender or server (S). The input of C is a set of inputs of size k, drawn from some domain of size N. S's input is a set of size k drawn from the same domain. (In other embodiments, the protocol is adapted to the case where the input sets have different sizes.)

Given two sets, X and Y, let XˆY denote the set of items which appear in both X and Y. At the conclusion of the protocol, C learns which specific inputs are shared by both C and S. That is, if

C's input is X={x1; . . . ; xk} and

S's input is Y={y1; . . . ; yk},

then C learns XˆY.

For private matching for the multiparty scenario, n parties are denoted P1, P2, . . . , Pn. Their input sets are X1, X2, . . . , Xn, respectively. At the conclusion of the protocol, there is a designated party whose output is ( . . . ((X1ˆX2)ˆX3)ˆ . . . ˆXn). Namely, the items which appear in all input sets.

Following are some basic variants of the private matching protocol. Private cardinality matching allows C to learn how many inputs it shares with S. That is, C learns the size of the intersection, but not the identity of the elements in it.

Private threshold matching provides C with the answer to the decisional problem whether the size of the intersection is greater than some pre-specified threshold t. That is, the output is 0 if the size of the intersection is smaller than t, and 1 otherwise.

In other embodiments, arbitrary private-matching protocols could be defined that are simple functions of the intersection set. For example, the output is 1 if and only if the size of the intersection is between a first threshold, t1, and a second threshold, t2.

In other embodiments, payload protocols may be defined. Payload protocols, in addition to learning the items in the intersection, provides an output that contains information associated with the intersection items. For example, in the two-party case, one party may be a law enforcement agency having a wanted suspect list and the other party may be a hotel with a guest registry. If a person appears in the intersection of the wanted suspect list kept by the agency and of the guest registry of the hotel, then the law enforcement agency learns the customer's identity. In addition, records that the hotel keeps for this customer, such as the guest's room number, may be provided to the law enforcement agency. The law enforcement agency learns no information about other guests of the hotel, and the hotel does not learn which guests appear in the intersection between its guest registry and the list of wanted suspects kept by the law enforcement agency.

In addition, it is possible to consider a protocol variant in which all parties (or any subset of them), rather than a single designated party, learn the output of the protocol. When the requesting party is to receive the results, the dataset comparison logic 130 prepares a suitable output report. If another part, such as the responding party described above, is to also receive information pertaining to the results, information corresponding to the results is output to the remote device such that its resident dataset comparison logic can generate a suitable report.

Returning to the example above, the hotel may learn that there is a guest who is also on the wanted suspect list of the law enforcement agency. In the multiparty scenario, one law enforcement agency may learn about the intersections with a plurality of hotel guest registries. In another multiparty scenario, a plurality of law enforcement agencies may learn about common wanted suspects staying at one or more hotels.

Embodiments of the information matching system 100 (FIG. 1) may employ homomorphic encryption schemes. Homomorphic encryption scheme constructions use a public-key encryption scheme, which is preferably semantically-secure, and which preserves the group homomorphism of addition, and allows multiplication by a constant. This property is obtained by a cryptosystem, such as, but not limited to, Paillier's cryptosystem, and subsequent constructions.

In one embodiment, the encryption system supports the following operations, which can be performed without knowledge of a private decryption key:

Given two encryptions Enc(m1) and Enc(m2), of messages m1 and m2, we can efficiently compute Enc(m1+m2), the encryption of m1+m2.

Given some constant c, we can compute Enc(c*m). Namely, the encryption of m multiplied by c.

Using the following corollary of these two properties:

Let P be a polynomial of degree k with coefficients a0, . . . , ak. Then given encryptions E(a0), . . . , E(ak), using a homomorphic encryption system, E(P(y)) is computed for any known value y. This computation is done by using the homomorphic properties to compute E(a0), E(a1*y), E(a2*yˆ2), . . . , E(ak*yˆk), and by then computing an encryption of the sum of these plain texts.

In some situations, both requesting party (C) and the responding party (S) are assumed to be semi-honest. That is, they act according to their prescribed actions in the protocol (namely, they both follow a defined protocol). However, one (or each) of them might try to use the messages it receives in the protocol from the other party in order to learn something about the other party's input which cannot be inferred from the output of the function. In the semi-honest scenario, one (or more) of the parties may try to use exchanged information for unintended purposes (thereby negating the objectives of secure and confidential private information matching).

The security definition is straightforward, particularly in the scenario where only one party (C) learns an output. We divide the requirements of secure and confidential private information matching into (i) protecting the client C and (ii) protecting the server/sender S.

The client's security (indistinguishability): Given that S gets no output from the protocol, the definition of C's privacy requires simply that S cannot distinguish between cases in which the C has different inputs. (In the multi-party case, “S” corresponds to any of the parties which are not supposed to learn any information pertaining to the final output of the protocol.)

S's security (comparison to the ideal model): The definition ensures that C does not get more information, or different information, than the output of the protocol function. This requirement is formalized by considering an ideal implementation where a trusted third party (TTP) gets the inputs of the two parties and outputs the defined function. In the real implementation by the various embodiments of the protocol, the client C does not learn different information. This ideal implementation is required of the protocol. (In the multi-party case, “C” corresponds to any party which is supposed to learn the output of the protocol.)

An embodiment of a private matching protocol is defined below. With respect to the defined protocol below, the operations associated with the requesting party C is understood to be performed through execution of the requesting party dataset comparison logic 130 (FIG. 1). Information that C acts on is the requesting party dataset 132. The operations associated with the responding party S is understood to be performed through execution of the responding party dataset comparison logic 136. Results of the completed protocol process is then saved into the comparison results 134 in a suitable format such that the requesting party is provided an output report having meaningful information pertaining to the dataset comparison results.

The Private Matching for set intersection (PM) protocol follows the following basic structure:

Party C defines a polynomial P [a nonencrypted polynomial P(y)]

whose roots are the inputs x1, . . . , xk.

Namely, P(y)=(x1−y)*(x2−y)* . . . *(xk−y)=ak*yˆk+ . . . +a1*y+a0

Party C sends to S homomorphic encryptions of the coefficients a0, a1, . . . , ak of this polynomial.

S uses the homomorphic properties of the encryption system to evaluate the polynomial at each of S's inputs [that is, for every y in Y compute E(P(y))]. S then multiplies each result by a fresh random number r to get an intermediate result, and adds to it an encryption of the value of S's input [i.e., S computes Enc(r*P(y)+y)].

Note that for each of the elements in the intersection of the two parties' inputs, P(y)=0. Therefore, the result of this computation is the value of the corresponding element y. On the other hand, for all other values of y the result is random.

The protocol is defined in detail as follows:

Protocol PM-Semi-Honest

Input: C's input is a set X={x1, . . . , xk}, S's input is a set Y={y1, . . . , yk}.

The elements in the input sets are taken from a domain of size N.

1. C performs the following operations:

(a) C selects the secret-key parameters for a semantically-secure homomorphic encryption scheme, and publishes its public keys and parameters. The plaintexts are in a field that contains representations of the N elements of the input domain, but is exponentially larger.

(b) C uses interpolation to compute the coefficients of the polynomial P(y)=(x1−y)*(x2−y)* . . . *(xk−y)=ak*yˆk+ . . . +a1*y+a0, of degree k, with roots x1, . . . , xk.

(c) C encrypts each of the (k+1) coefficients by the semantically-secure homomorphic encryption scheme and sends to S the resulting set of ciphertexts, {Enc(a0), . . . , Enc(ak)}.

Then, the information is communicated to S

2. S performs the following for every y in Y,

(a) S uses the homomorphic properties to evaluate the encrypted polynomial at y. That is, S computes Enc(P(y))=Enc(ak*yˆk+ . . . +a1*y+a0).

(b) S selects a random value r and computes Enc(rP(y)+y).

(c) S randomly permutes this set of k ciphertexts.

Then, S sends the result back to the client C.

3. C decrypts all k ciphertexts received. C locally outputs all values x in X for which there is a corresponding decrypted value.

Alternative embodiments provide (compute) payloads associated with items in the intersection of the two datasets. Assume that S associates with each item y in its set some “payload” defined as data p_y. For example, if S is a hotel and Y is the list of the names of its guest, the payload data for S might include additional information about this guest. For example, the dates of the guest's stay in the hotel, and/or the guest's room number, may comprise the payload data.

The basic PM protocol can be changed to support payload data. The change occurs in Step 2(b), where instead of computing E(rP(y)+y), S computes Enc(rP(y)+(y|p_y)), where “|” denotes concatenation. C obtains p_y if, and only if, y is in the intersection of the two datasets.

As the computational overhead of exponentiations dominates that of other operations, computational overhead of the protocol may be evaluated by counting exponentiations. Equivalently, the number of multiplications of homomorphically-encrypted values by constants [in Step 2(a)] is counted, as these multiplications are actually implemented as exponentiations.

Given the encrypted coefficients of a polynomial P, a naive computation of Enc(P(y)) results in an overhead of O(k) exponentiations. Hence, computational overheads may be determined by the total of O(kˆ2) exponentiations for the whole protocol.

The computational overhead can be reduced since the input domain is typically much smaller than the modulus used by the encryption scheme. Hence, the values x, y may be encoded as numbers in the smaller domain. In addition, Homer's rule can be used to evaluate the polynomial more efficiently by eliminating large exponents. Application of Homer's rule yields a significant (large constant factor) reduction in the overhead.

Exponents from a small domain may also be considered by some embodiments. Let s be the security parameter of the encryption scheme (e.g., s is the modulus size). A preferred choice is s=1024 or larger. Yet, the input sets are usually of size <<2ˆs, and may be mapped into a small domain of length n=2 log k bits using pairwise-independent hashing, which induces only a small collision probability. The server S should compute Enc(P(y)), where y is n bits long.

A first overhead reduction is realized by applying Homer's rule: P(y)=a0+a1y+a2yˆ2+ . . . +ak*yˆk is evaluated “from the inside out” as a0+y(a1+y(a2+y(a3+ . . . y*ak) . . . ))). Each intermediate result is multiplied by a short y, compared with yˆi in the naive evaluation. This results in k short exponentiations.

Comparing this to using the “text book” algorithm for computing exponentiation, the computational overhead is linear in the length of the exponent. Therefore, Homer's rule improves this overhead by a factor of s/n (which is about 50 for k=1000). The gain is substantial even when fine-tuned exponentiation algorithms, such as, but not limited to, Montgomery's method or Karatsuba's technique are used.

The PM protocol's main computational overhead results from the server S computing polynomials of degree k. In alternative embodiments, the degree of these polynomials is reduced. For that, alternate embodiments employ a process that distributes C's elements into B bins, such that each bin contains at most M elements.

C now defines a polynomial of degree M for each bin: All items mapped to the bin by some hash function, h, are defined to be roots of the polynomial. In addition, C adds the root x=0 to the polynomial, with multiplicity which sets the total degree of the polynomial to M. That is, if C maps L items (L<M) to the bin, then C first defines a polynomial whose roots are these L values, and then multiplies it by xˆ(M−L). (The function assumes that 0 is not a valid input.) The process results in B polynomials, all of them of degree M, that have a total of k non-zero roots.

C sends the results of the above-described process to S (the encrypted coefficients of the polynomials, and the mapping from elements to bins). For every y in Y, S finds the bins into which y could have been mapped, and evaluates the polynomials of those bins. S then proceeds as described above, and responds to C with the encryptions rP(y)+y for every possible bin allocation for all y.

Security of the PM-Semi-Honest scenario follows from the following assertions, which are easily proved by methods which are common in the field of the invention.

Assertion 1 (Correctness): Protocol PM-Semi-Honest evaluates the PM function with high probability. (The proof is based on the fact that C receives an encryption of y for y in XˆY, and an encryption of a random value otherwise.)

Assertion 2 (C's privacy is preserved): If the encryption scheme is semantically secure, then the views of S for any two inputs of C are indistinguishable. (The proof uses the fact that the only information that S receives consists of semantically-secure encryptions.)

Assertion 3 (S's privacy is preserved): For every probabilistic polynomial time (PPT) machine C′ playing the role of C in the protocol, there is a PPT machine C″ playing the client in an ideal implementation, such that for every input Y of S the views of C′ and C″ are indistinguishable. (The proof defines a polynomial whose coefficients are the plaintexts of the encryptions sent by C to S. The k roots of this polynomial are the inputs that C sends to the trusted third party in the ideal implementation.)

In an alternative embodiment providing a Private Matching for set Cardinality (PMC) protocol, C learns the cardinality of the intersection of X and Y, but not the actual elements of this set. S needs only slightly change its behavior from that in Protocol PM-Semi-Honest to enable this functionality. Instead of encoding y in Step 2(c), S now only encodes some “special” string, such as a string of 0's. I.e., S computes Enc(rP(y)+00 . . . 0). In Step 3 of the protocol, C counts the number of ciphertexts received from S that decrypt to the string 00 . . . 0 and outputs this number. The proof of security for this protocol follows from that of the above-described PM-Semi-Honest scenario.

In a protocol embodiment, private matching for cardinality threshold matching (PMt) may be provided. Here, C only learns whether the number of items in the intersection is greater than some predefined threshold, t. To enable this functionality, PM-Semi-Honest protocol is changed as follows:

(i) In Step 2(c) S encodes random numbers instead of y in PM (or 00 . . . 0 in PMC). That is, S computes Enc(rP(y)+r_y), for random r_y of S's choice.

(ii) Following the basic PM protocol, C and S engage in a secure computation evaluation protocol of the following function, preferably encoded as a circuit. The circuit takes as input k values from each party: C's input is the ordered set of plaintexts C recovers in Step 3 of the PM protocol. S's input is the list of random payloads S chooses in Step 2(c), in the same order that C sends them. The function first computes the equality of these inputs bit-by-bit, which requires k log k gates. Then, the function computes a threshold function on the results of the k comparisons. Hence, the threshold protocol has the initial overhead of a PM protocol plus the overhead of a secure circuit evaluation protocol. Note, however, that the overhead of function evaluation is not based on the input domain of size N. Rather, the function first needs to compute equality on the input set of size k, then compute some simple function of the size of the intersection set. In fact, this protocol can be used to compute any function of the intersection set (e.g., check if c within some range, not merely the threshold problem).

In some situations, one or more of the parties may be expected to act in a malicious manner (or at least there is a possibility of a party acting in a malicious manner). That is, protocol must be structured such that a party that is not supposed to learn about information that may be received during the comparison process. Accordingly, modifications may be made to the above-described protocol embodiments in order to provide security in the malicious adversary model. The modifications are based on protocol PM-Semi-Honest scenario, and can be also applied to the protocols that use hashing. Similar modifications can also be applied to the protocol embodiments that were designed for the multi-party scenario.

To ensure security against a malicious client, C, a protocol is designed such that for any possible behavior by C in the real model, there is an input of size k that C provides to the TTP in the ideal model. C's view in the real protocol is efficiently simulatable from C's view in the ideal model.

A first malicious party protocol embodiment provides a solution for the basic protocol that does not use hashing. Note that if a value y is not a root of the polynomial sent by the client C, C cannot distinguish whether this item is in S's input. Accordingly, the possibility that C sends the encryption of a polynomial with more than k roots is considered. This can only happen if all the encrypted coefficients are zero (P's degree is indeterminate). The protocol is modified to require that at least one coefficient is non-zero.

In Step 1(b) of the above-described Protocol PM-Semi-Honest, C generates the coefficients of P with a0 (the free coefficient) set to 1. C then sends encryptions of the other coefficients to S.

Now, in the protocol embodiment that uses hashing, C sends encryptions of the coefficients of B polynomials (one per bin), each of degree M. S must ensure that the total number of roots (different than 0) of these polynomials is k. For that, a cut-and-choose method is used, as shown in Protocol PM-Malicious-Client below. Using L copies, which results in an overhead which is L times that of the original protocol, an error probability is determined that is exponentially small in L.

Protocol PM-Malicious-Client

Input: C has input X of size k, and S has input Y of size k, as before.

1. C performs the following operations:

(a) C chooses a key for a pseudo-random function that realizes a hash function h, and C sends it to S.

(b) C chooses a key s for a pseudo-random function F and gives each item x in C's input X a new pseudo-identity, Fs(G(x)), where G is a collision-resistant hash function.

(c) For each of C's polynomials, C first sets roots to the pseudo-identities of such inputs that were mapped to the corresponding bin. Then, C adds a sufficient number of 0 roots to set the polynomial's degree.

(d) C repeats steps (b), (c) for L times to generate L copies, using a different key s for F in each iteration.

2. S asks C to open L/2 of the copies, chosen by S.

3. C opens the encryptions of the coefficients of the polynomials for these L/2 copies to S, but does not reveal the associated keys s. Additionally, C sends the keys s used in the unopened L/2 copies.

4. S verifies that the each opened copy contains k roots. If this verification fails, S halts. Otherwise, S uses the additional received L/2 keys, along with the hash function G, to generate the pseudo-identities of S's inputs. S runs the protocol for each of the polynomials. However, for an input y, rather than encoding y as the payload for each polynomial, S encodes L/2 random values whose exclusive-or is y.

5. C receives the results, organized as a list of k sets of size L/2. C decrypts them, computes the exclusive-or of each set, and compares it to C's input.

In some situations, a malicious server, S, may be encountered. The protocol for the PM-Semi-Honest embodiment enables a malicious server to attack the correctness of the protocol. S can play tricks like encrypting the value r (P(y1)+P(y2))+y3 in Step 2(c) above in the PM-Semi-Honest embodiment, so that C concludes that y3 is in the intersection set if both y1 and y2 are in X. This behavior does not correspond to the definition of PM in the ideal model. Intuitively, this problem arises from S using two ‘inputs’ in the protocol execution for input y: a value for the polynomial evaluation, and a different value used as a payload. However, in the ideal model, S has a single input.

To counter the malicious server, S, situation, the above described protocol embodiment for the PM-Semi-Honest can be modified to provide security against malicious servers. The protocol based on the use of hash functions may be modified similarly. Intuitively, S must be forced to run according to its procedure prescribed by PM-Semi-Honest protocol. This can be enforced by requiring S to use a zero-knowledge proof, or a similar tool, to prove that S's operation follows the protocol.

Some embodiments may provide for a multi-party scenario. For example, consider n parties P1, P2, . . . , Pn, with private input sets X1, X2, . . . , Xn. Without loss of generality, assume that each list contains k inputs. The parties compute the intersection of all lists.

Describing a basic multi-party protocol, which is secure with respect to parties P1, P2, . . . , P(n−1), but not against party Pn, is provided below. The protocol can then be modified to provide security against all parties.

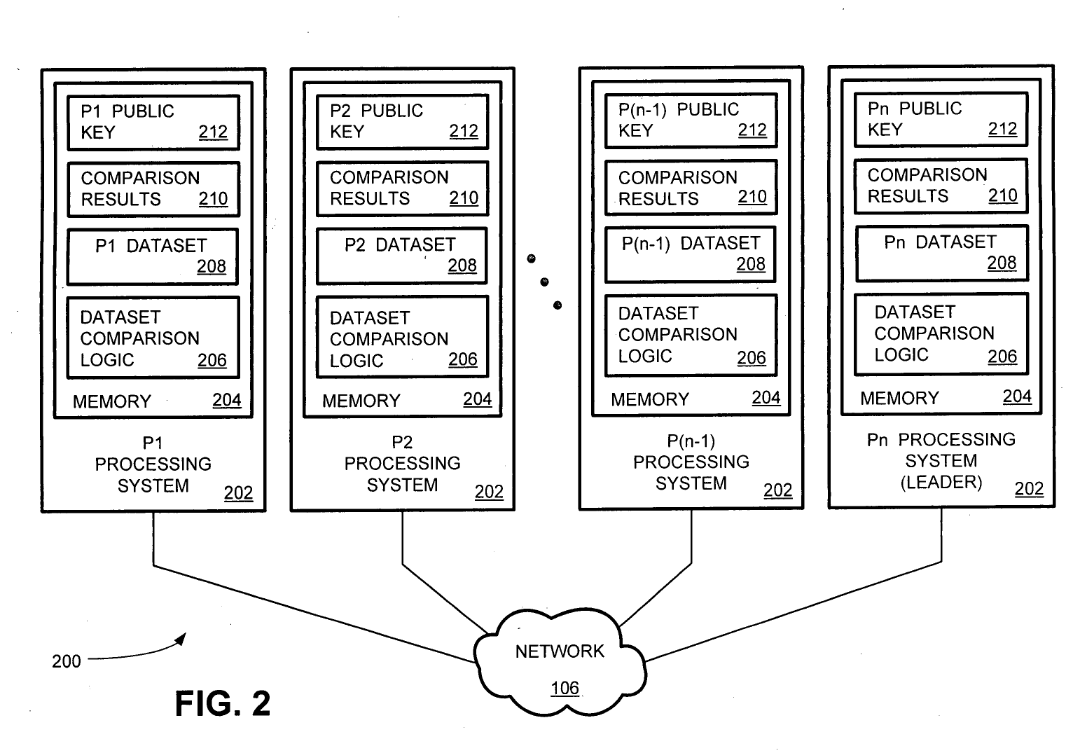

FIG. 2 is a block diagram of a multi-party embodiment of a private information matching system 200. A plurality of processing systems, P1 through Pn, are communicatively coupled together via a network 106. Processing systems 202 may be configured similarly to systems 102/104 (FIG. 1), and accordingly, such similarities are not discussed again.

Each system 202 includes a memory 204. Residing in memory 204 is the dataset comparison logic 206 which performs the various operations and functions described hereinbelow. Also residing in memory are the datasets 208 associates with each processing system 202. If results are provided to o party associated with one of the processing systems 202, the comparison results 210 would reside in memory 202. Each of the systems 202 provide for a public key 212, as described hereinbelow.

A basic multi-party protocol is defined as follows:

Let parties P1, P2, . . . , Pn each generate a polynomial encoding their input, as in Protocol PM-Semi-Honest in the two-party case. Each client C uses their own public key and sends the encrypted polynomials to Pn, which we refer to as the leader. This naming of parties as clients and leader is done for conceptual clarity.

For each item y in the leader's list, leader Pn prepares (n−1) random shares that add to y. The leader then evaluates the (n−1) polynomials received, encoding the i^{th} share of y as the payload of the evaluation of the ith polynomial. The leader then publishes a shuffled list of (n−1)-tuples. Each tuple contains the encryptions that the leader obtained while evaluating the polynomials for input y, for every y in S's input set. Note that every tuple contains exactly one entry encrypted with the key of client Pi, for 1=i, . . . , n−1.

To obtain the outcome, each client Pi decrypts the entries that are encrypted with S's public key and publishes them. If XOR-ing the decrypted values in a tuple results in y, then y is in the intersection.

This basic protocol does not provide security against the leader Pn since the leader is the one who generates the shares that the clients decrypt. Hence, the leader may recognize, for values y in S's set but not in the intersection, which clients also hold y. These clients, and only these clients, would publish the shares generated by Pn.

The following secure protocol fixes this problem by letting each client generate random shares that XOR to zero for each input, and then each client gives one encrypted share per input to every other client. Then, the clients publish the XOR of the original share they received from the leader with the new shares from other clients. If y is in the intersection set, then the XOR of all published values per input is still y, otherwise it looks random to any coalition of parties.

A secure multi-party protocol employed by various embodiments may be defined as follows:

1. Each party Pi, for i=1, . . . , n−1 operates as in the two-party case. S generates a polynomial Qi of degree k encoding S's inputs, and generates homomorphic encryptions of its coefficients (with S's own public key). Pi also selects k sets, each with n−1 random numbers, namely {s(i,j,1), s(i,j,2), . . . , s(i,j,n−1)} for j=1 . . . k. These elements can be viewed as a matrix with k rows and (n−1) columns. Each column corresponds to the values given to a certain party. Each row corresponds to the random numbers generated for one of the inputs of Pi.

A matrix is chosen such that the XOR of each row sums to zero, i.e., it holds for j=1, . . . , k that s(i,j,1) xor s(i,j,2) xor . . . xor s(i,j,n−1)=0.

For each column c, Pi encrypts the corresponding shares using the public key of client Pc. S sends all of the encrypted data to a public bulletin board (or just to the leader who acts in such a capacity). Alternatively, Pi can send directly to Pc the encryptions that were done with the public key of Pc.

2. The leader Pn prepares, for each item y in Pn's list Xn, n−1 random shares t(y,1), t(y,2), . . . , t(y,n−1) (one for each column), where the xor of all these values is y. Namely t(y,1) xor t(y,2) xor . . . xor t(y,n−1)=y. Then, for every Pi, for each of the k elements of the matrix column representing client Pi, the leader computes the encryption of r(y,i)*Qi(y)+t(y,i) using Pi's public key and a fresh random number r(y,i).

In total, the leader generates k tuples of (n−1) items each. The leader randomly permutes the order of the tuples and publishes the resulting data.

3. Each client Pi decrypts the entries that are encrypted with its public key. Namely, one column generated by Pn (of k elements) and (n−1) columns generated by the parties P1 through P(n−1) (also of k elements). The parties P1 through P(n−1) compute the XOR of the elements of each row in the resulting matrix: s(1,j,i) xor s(2,j,i) xor . . . xor s(n−1,j,i) xor t(j,i). Pi then publishes these k results.

4. Each Pi checks if the XOR of the (n−1) published results for each row is equal to a value y in its input. If this is the case, Pi concludes that y is in the intersection.

Intuitively, the values output by each client (Step 3) appear random to the leader, and therefore the leader cannot identify outputs from clients with y in their input (as the leader could in the basic protocol).

Note that the communication involves two rounds in which P1, . . . , P(n−1) submit data, and a round where Pn submits data. This protocol is preferable to protocols consisting of many rounds which involve communication between all parties. The computation overhead of Pn can be improved by using the hashing-to-bins method described above in the two-party scenario.

In addition, the other variants that were described for the two-party protocol can also be applied to the multi-party protocol described herein.

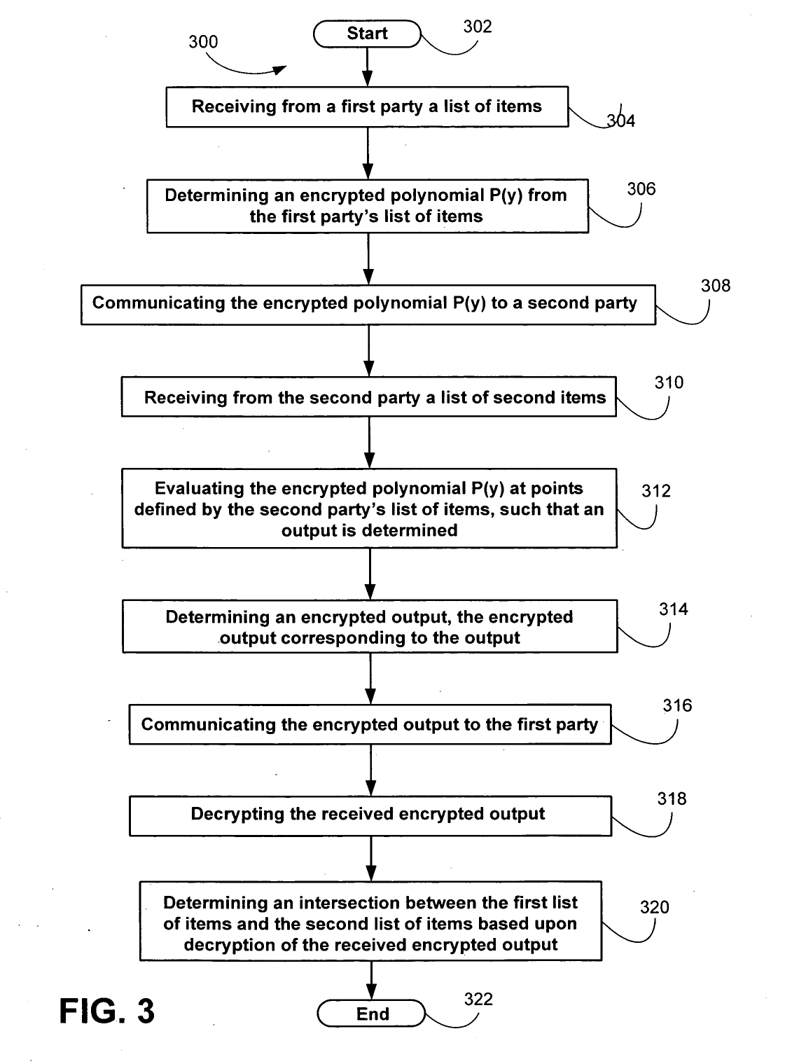

FIG. 3 is a flowchart illustrating an embodiment of a process for confidentially matching information among parties. The flow chart 300 shows the architecture, functionality, and operation of an embodiment for implementing the dataset comparison logic 130, 136 and/or 206 (FIGS. 1-2) such that matching information among parties is confidentially determined. An alternative embodiment implements the logic of flow chart 300 with hardware configured as a state machine. In this regard, each block may represent a module, segment or portion of code, which comprises one or more executable instructions for implementing the specified logical function(s). It should also be noted that in alternative embodiments, the functions noted in the blocks may occur out of the order noted in FIG. 3, or may include additional functions. For example, two blocks shown in succession in FIG. 3 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

The process begins at block 302. At block 304, a list of items is received from a first party. At block 306, an encrypted polynomial P(y) from the first party's list of items is determined. At block 308, the encrypted polynomial P(y) is communicated to a second party. At block 310, a list of second items is received from the second party. At block 312, the encrypted polynomial P(y) is evaluated at points defined by the second party's list of items, such that an output is determined. At block 314, an encrypted output is determined, the encrypted output corresponding to the output. At block 316, the encrypted output is communicated to the first party. At block 318, the received encrypted output is decrypted. At block 320, an intersection between the first list of items and the second list of items is determined based upon decryption of the received encrypted output. The process ends at block 322

Embodiments of the private information matching system 100 implemented in memory 114, 124 and/or 204 (FIGS. 1-2) may be implemented using any suitable computer-readable medium. In the context of this specification, a “computer-readable medium” can be any means that can store, communicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

With respect to the responding processing system 104 (FIG. 1), the responding party dataset comparison logic 136 and the responding party dataset 138 reside in memory 114. Since with this illustrative embodiment the responding party does not receive results of the comparison, there are no comparison results. However, if comparison results are provided to the responding party, the results would reside in memory 124 or in another suitable memory accessible by the responding party.

The processing system 102 and a responding system 104 include suitable input/output devices, here illustrated as a display and keyboard device 140. Any suitable input/output device may be used such that the requesting part and the responding party are able to provide input to the requesting party dataset comparison logic 130 and the responding party dataset comparison logic 136, respectively

Network 106 may be any type of suitable communication system. Non-limiting examples of network 106 include standard telephony systems, frame relay based systems, internet or intranet systems, local access network (LAN) systems, Ethernet systems, cable systems, a radio frequency (RF) systems, cellular systems, or the like. Furthermore, network 106 may be a hybrid system comprised of one or more of the above-described systems.

In some embodiments, the private information matching system 100 may be implemented on a single processing system. That is, both the requesting party and the responding party may use the same processing system. Accordingly, the requesting party dataset 132 and/or the responding party dataset 138 may reside in memory 124, or in another suitable memory device. All computations are performed by processor 112.

In alternative embodiments of systems 102 and/or 104, the above-described components may be connectivley coupled each other in a different manner than illustrated in FIG. 1. For example, one or more of the above-described components may be directly coupled to processors 112/122, or may be coupled to processors 112/114 via intermediary components (not shown). Also, the connections 108 were illustrated as hard wire connections for convenience. The systems 102 and/or 106 may be communicatively coupled to the network using any suitable communication medium.

The above described processing systems 102, 106 and/or 202 are described as executing the various embodiments of the dataset comparison logic. The various embodiments of the dataset comparison logic may report the results of the comparisons in any suitable manner. For example, if only the instances of matches are to be reported, then the output report generated by the dataset comparison logic may be configured in any suitable manner that imparts that information to the user. If payload data is to be included in the output report, the dataset comparison logic may be configured in any suitable manner that imparts that information to the user. It is appreciated that the output can me presented in any suitable manner, and that such variations in possible output report formats are too numerous to describe herein. Any such output format is intended to be included herein within the scope of this disclosure and protected by the following claims.

The above-described dataset comparison logic used by the various embodiments may me the same, or may be different, for the various users. For example, if one of the users is not to see the output, the embodiment used by that user need not have output reporting algorithms.

It should be emphasized that the above-described embodiments are merely examples of the disclosed system and method. Many variations and modifications may be made to the above-described embodiments. All such modifications and variations are intended to be included herein within the scope of this disclosure and protected by the following claims.

What is claims is:

1. A method for confidentially matching information among parties, comprising:
receiving from a first party a list of items;
determining an encrypted polynomial P(y) from the first party's list of items;
communicating the encrypted polynomial P(y) to a second party;
receiving from the second party a list of second items;
evaluating the encrypted polynomial P(y) at points defined by the second party's list of items, such that an output is determined;
determining an encrypted output, the encrypted output corresponding to the output;
communicating the encrypted output to the first party;
decrypting the received encrypted output; and
determining an intersection between the first list of items and the second list of items based upon decryption of the received encrypted output.

2. The method of claim 1, wherein the number of items in the first party's list equals the number in items of the second party's list.

3. The method of claim 1, wherein the number of items in the first party's list is different from the number of items in the second party's list.

4. The method of claim 1, wherein the first party's list of items comprises items corresponding to x1 through xk, and wherein the second party's list of items comprises items corresponding to y1 through yk.

5. The method of claim 4, wherein determining the encrypted polynomial P(y) further comprises determining a nonencrypted polynomial having the form of:
(nonencrypted polynomial)=(x1−y)*(x2−y)* . . . *(xk−y)=ak*yˆk+ . . . +a1*y+a0, such that the encrypted polynomial P(y) is determined from the nonencrypted polynomial.

6. The method of claim 4, wherein determining the encrypted polynomial P(y) further comprises determining homomorphic encryptions of the coefficients a0, a1, . . . , ak of P(y) such that the encrypted polynomial P(y) is determined from the homomorphic encryptions of the coefficients a0, a1, . . . , ak of P(y).

7. The method of claim 4, the output having the form of:
Enc(P(y))=Enc(ak*yˆk+ . . . +a1*y+a0)

8. The method of claim 4, wherein determining the encrypted output further comprises:
modifying the encrypted polynomial P(y) to generate a second encrypted polynomial;
evaluating the second encrypted polynomial at y1 through yk, such that a second output is determined; and
encrypting the second output such that the encrypted output is determined.

9. The method of claim 4, wherein determining the encrypted output further comprises:
selecting a random value r;
computing the encrypted output having a form of Enc(rP(y)+y); and
randomly permuting a set of k ciphertexts.

10. The method of claim 9, further comprising:
communicating a third encrypted polynomial with the permutated set of k ciphertexts to the first party; and
decrypting the received permuted set of k ciphertexts.

11. The method of claim 9, further comprising:
associating payload information with each of the items corresponding to y1 through yk;
locally outputting the payload information corresponding to all values y1 through yk for which there is a corresponding decrypted value of the k ciphertexts.

12. The method of claim 11, wherein computing a third encrypted polynomial having a form of Enc(rP(y)+y) is replaced by computing a fourth encrypted polynomial having the form of Enc(rP(y)+(y|p_y)), where “|” denotes concatenation.

13. The method of claim 4, further comprising applying Homer's rule to:
P(y)=a0+a1y+a2yˆ2+ . . . +ak*yˆk, so that P(y) is evaluated as:
P(y)=a0+y(a1+y(a2+y(a3+ . . . y*ak) . . . ))).

14. The method of claim 1, further comprising locally outputting information corresponding to all the first party's list of items for which there is a correspondence to the received encrypted output, wherein the received encrypted output corresponds to the second party's list of items.

15. The method of claim 1, further comprising remotely outputting the information corresponding to all the first party's list of items for which there is a correspondence to the received encrypted output, wherein the received encrypted output corresponds to the second party's list of items, such that the second party may access the remotely output information.

16. The method of claim 1, wherein determining the encrypted output further comprises:
modifying the output to generate a second output; and
encrypting the second output such that the encrypted output is determined.

17. The method of claim 1, wherein determining P(y) further comprises:
selecting a secret-key parameter for a semantically-secure homomorphic encryption scheme; and
publishing a public key and associated parameters.

18. The method of claim 1, further comprising interpolating to compute coefficients of P(y).

19. The method of claim 1, further comprising:
associating payload information with each of the items corresponding to, the second party's list of items; and
locally outputting the payload information corresponding to values of the determined intersection.

20. The method of claim 1, further comprising:
determining a number of intersections between the items corresponding to the first party's list of items and the second party's list of items;
comparing the number of intersections with a predefined threshold t;
outputting a first value when the number of intersections is at least equal to t; and
outputting a second value when the number of intersections is greater than t.

21. The method of claim 20, further comprising:
comparing the number of intersections with a predefined second threshold t;
outputting the first value when the number of intersections is less than t;
outputting the second value when the number of intersections is at least equal to t and less than the second t; and
outputting a third value when the number of intersections is greater than the second t.

22. The method of claim 1, further comprising:
determining a number of intersections between the items corresponding to the first party's list of items and the second party's list of items;
comparing the number of intersections with a predefined threshold t; and
outputting information corresponding to the number of intersections when the number of intersections is at least equal to t.

23. The method of claim 1, further comprising:
defining a polynomial of degree M for each of a plurality of bins;
mapping roots of the polynomial of degree M into the bins using a hash function;
adding a root to the polynomial of degree M using a multiplicity which sets a total degree of the polynomial to M; and
mapping the items corresponding to the first party's list of items into the bins, such that each bin contains at most M elements,
such that a plurality of B polynomials are formed having a degree of M and that have a total of k non-zero roots.

24. The method of claim 23, further comprising:
communicating the plurality of B polynomials having the degree of M to the second party;
for each of the items corresponding to the second party's list of items, mapping those to the bins;
encrypting, for each of the bins, the B polynomials according to rP(y)+y; and
communicating the result of the encrypting to the first party.

25. The method of claim 1, further comprising:
communicating the encrypted polynomial P(y) to a third party;
receiving from the third party a list of third items;
evaluating the encrypted polynomial P(y) at the third party's list of items, such that a second output is determined;
determining a second encrypted output, the second encrypted output corresponding to the second output;
communicating the second encrypted output to the first party; and
decrypting the received second encrypted output; and
determining an intersection between the first list of items, the second list of items, and the third list of items based upon decryption of the received first and second encrypted outputs.

26. The method of claim 1, further comprising:
communicating the encrypted polynomial P(y) to a plurality of other parties;
receiving from each of the plurality of other parties a list of items;
evaluating a plurality of encrypted polynomial P(y) at each of the plurality of other parties' list of items, such that a plurality of second outputs are determined;
determining a plurality of second encrypted outputs, the second encrypted outputs corresponding to their respective second outputs;
communicating the plurality of second encrypted outputs to the first party; and
decrypting the received plurality of second encrypted outputs; and
determining an intersection between the first list of items, the second list of items and the plurality of other parties' list of items, based upon decryption of the received encrypted outputs.

27. A method for confidentially matching information among two parties, comprising:
receiving from a first party a list of items, the items corresponding to x1 through xk;
determining a polynomial P(y) from the first party's list of items, P(y) having roots corresponding to x1 through xk and having the form of:
P(y)=(x1−y)*(x2−y)* . . . *(xk−y)=ak*yk+ . . . +a1*y+a0;
determining a homomorphic encryptions of coefficients a0, a1, . . . , ak of P(y);
determining an encrypted polynomial from the homomorphic encryptions of the coefficients a0, a1, . . . , ak of P(y);
communicating the encrypted polynomial to a second party;
receiving from the second party a list of second items, the items corresponding to y1 through yk;
evaluating the encrypted polynomial at y1 through yk, such that a first output is determined, the first output having the form of:
Enc(P(y))=Enc(ak*yˆk+ . . . +a1*y+a0);
selecting a random value r;
computing a second output having the form of Enc(rP(y)+y);
randomly permuting a set of k ciphertexts in the second output;
communicating the second output with the permutated set of k ciphertexts to the first party;
decrypting the received permuted set of k ciphertexts; and
locally outputting information corresponding to all values x1 through xk for which there is a corresponding decrypted value of the k ciphertexts.

28. A method for confidentially matching information among a plurality of n parties, comprising:
generating a polynomial Qi of degree k by encoding inputs of a plurality of items associated with a lead party Pn;
generating a homomorphic encryption of coefficients of Qi using a public key of the lead party;
for each of the parties P1 through P(n−1), selecting k sets of items, each with n−1 random numbers{s(i,j,1), s(i,j,2), . . . , s(i,j,n−1)} for j=1 . . . k;
constructing a matrix with k rows and (n−1) columns, wherein each column of the matrix corresponds to values given to a certain party, and wherein each row of the matrix corresponds to random numbers generated for one of the inputs of Pi, and such that XOR of each row sums to zero;
for each of the parties P1 through P(n−1), encrypting each column using a public key of a public client Pc;
communicating to the lead party Pn the encrypted matrix;
preparing, by the lead party Pn for each item in Pn's list Xn, n−1 random shares t(y,1), t(y,2), . . . , t(y,n−1), one for each column, wherein the xor of all the values in accordance with:
y=t(y,1) xor t(y,2) xor . . . xor t(y,n−1);
computing an encryption of r(y,i)*Qi(y)+t(y,i) using the public key and a fresh random number r(y,i);
generating k tuples of (n−1) items each by the lead party Pn;
randomly permuting the order of the tuples by the lead party Pn;
publishing the resulting permuted tuples by the lead party Pn to the parties P1 through P(n−1);
decrypting by the parties P1 through P(n−1) the encryption of r(y,i)*Qi(y)+t(y,i) using the public key, such that one column is generated by Pn (of k elements) and (n−1) columns are generated by the parties P1 through P(n−1) (also of k elements);
computing by the parties P1 through P(n−1) an XOR of elements of each row in the resulting matrix in accordance with:
s(1,j,i) xor s(2,j,i) xor . . . xor s(n−1,j,i) XOR t(j,i)
publishing the resulting matrix by the parties P1 through P(n−1);
checking if the XOR of the (n−1) published results; and
concluding that an item is in an intersection when the results for each row is equal to a value y in its input.

29. A system that confidentially matches information among parties, comprising:
a list of items generated by a first party;
a first processing system configured to determine an encrypted polynomial P(y) from the first party's list of items and configured to communicate the encrypted polynomial P(y) to a second processing system;
a list of second items generated by a second party; and
the second processing system configured to evaluate the encrypted polynomial P(y) at the second party's list of items such that an output is determined, configured to determine an encrypted output from the output, configured to communicating the encrypted output to the first processing system;
such that the first processing system decrypts the received encrypted output and determines an intersection between the first list of items and the second list of items based upon decryption of the received encrypted output.

30. A program for confidentially matching information among parties stored on computer-readable medium, the program comprising logic configured to perform:
receiving a list of items generated by a first party;
determining an encrypted polynomial P(y) from the first party's list of items;
communicating the encrypted polynomial P(y) to a second program that receives a list of second items generated by a second party, that evaluates the encrypted polynomial P(y) at the second party's list of items such that an output is determined, and that determines an encrypted output, the encrypted output corresponding to the output;
receiving the encrypted output from the second program;
decrypting the received encrypted output; and
determining an intersection between the first list of items and the second list of items based upon decryption of the received encrypted output.

31. A program for confidentially matching information among parties stored on computer-readable medium, the program comprising logic configured to perform:
receiving an encrypted polynomial P(y) from a second program, the encrypted polynomial P(y) based upon a list of items generated by a first party;
receiving a list of items generated by a second party;
evaluating the encrypted polynomial P(y) at the second party's list of items, such that an output is determined;
determining an encrypted output, the encrypted output corresponding to the output; and
communicating the encrypted output to the second program;
such that the encrypted output received by the second program is decrypted, and such that an intersection between the first list of items and the second list of items based upon decryption of the received encrypted output is determined by the second program.
